(19) United States
(12) Patent Application Publication
(10) Pub. No.: US 2010/0153591 A1
(43) Pub. Date: Jun. 17, 2010

(54) INTERFACE UNIT AND ELECTRONIC SYSTEM INCLUDING THE SAME

(75) Inventor: Sung-Goo Cho, Seoul (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/635,765

(22) Filed: Dec. 11, 2009

(30) Foreign Application Priority Data
Dec. 12, 2008 (KR) 10-2008-0126502

(51) Int. Cl. G06F 13/00

(52) U.S. Cl. 710/33; 710/74

(57) ABSTRACT

An electronic system includes a central processing unit and an interface unit. The interface unit includes a plurality of first interfaces for connecting a plurality of host devices, and a plurality of second interfaces for connecting a plurality of data storage devices. The interface unit further includes a controller for controlling data communication, independently of the central processing unit, among the plurality of host devices and the plurality of data storage devices via the plurality of first interfaces and the plurality of second interfaces

### CROSS-REFERENCE TO RELATED APPLICATIONS

A claim of priority is made to Korean Patent Application No. 10-2008-0126502, filed Dec. 12, 2008, in the Korean Intellectual Property Office, the disclosure of which is incorporated herein in its entirety by reference.

### BACKGROUND

The inventive concepts described herein generally relate to electronic data systems, and more particularly, the inventive concepts relate to interface units for exchanging data between with a plurality of host devices and a plurality of data storage devices.

Electronic systems generally include a central processing unit for executing a variety of applications dependent upon, for example, the functionality of system and user commands. In addition, in a network of multiple electronic systems, each having their own central processing unit, the systems often capable of exchanging data with one another.

Generally, in a data input process of an electronic system, data received from a remote electronic system via an interface is temporarily stored in a buffering device of the receiving electronic system. The data temporarily stored in the buffering device is then transcribed to a data storage device of the receiving electronic system. This process is typically executed under the control of the central processing unit of the receiving device.

In a data output process, data is read from the data storage device and again may be temporarily stored in the buffering device. The temporarily stored data is then transmitted from the buffering device via the interface to a remote electronic system. This process is also typically executed under the control of the central processing unit of the transmitting system.

### SUMMARY

The inventive concepts provide an interface unit which has a built-in controller to store data directly in a data storage device and have the data stored in the data storage device shared by a plurality of host devices.

According to an aspect of the inventive concepts, an interface unit is provide which includes a plurality of first interface devices for connecting a plurality of host devices, and a plurality of second interface devices for connecting a plurality of data storage devices. The interface unit further includes a controller for controlling data communication among the plurality of host devices and the plurality of data storage devices via the plurality of first interfaces and the plurality of second interfaces.

According to another aspect of the inventive concepts, an electronic system is provided which includes a central processing unit and an interface unit. The interface unit includes a plurality of first interfaces for connecting a plurality of host devices, and a plurality of second interfaces for connecting a plurality of data storage devices. The interface unit further includes a controller for controlling data communication, independently of the central processing unit, among the plurality of host devices and the plurality of data storage devices via the plurality of first interfaces and the plurality of second interfaces.

### BRIEF DESCRIPTION OF THE DRAWINGS

Exemplary embodiments of the inventive concepts will be more clearly understood from the following detailed description taken in conjunction with the accompanying drawings in which:

FIG. 1 is a block diagram of an electronic system according to an exemplary embodiment of the inventive concepts;

FIG. 2 is a flowchart for explaining a data input/output method in the electronic system of FIG. 1 according to an exemplary embodiment of the inventive concepts;

FIG. 3 is a block diagram for explaining a data communications method between an electronic system, a notebook, and a PC, according to an exemplary embodiment of the inventive concepts;

FIG. 4 is a flowchart for explaining a data communication method between the electronic system, the notebook, and the PC associated with FIG. 3 according to an exemplary embodiment of the inventive concepts;

FIG. 5 is a block diagram for explaining a data communication method between an electronic system and a notebook, according to another exemplary embodiment of the inventive concepts; and

FIG. 6 is a flowchart for explaining a data communications method between the electronic system and the notebook associated with FIG. 5 according to an exemplary embodiment of the inventive concepts.

### DETAILED DESCRIPTION OF THE EMBODIMENTS

The attached drawings for illustrating embodiments of the inventive concepts are referred to in order to gain a sufficient understanding of the inventive concepts and the merits thereof. Hereinafter, the inventive concepts will be described in detail by explaining embodiments of the inventive concepts with reference to the attached drawings. Like reference numerals in the drawings denote like elements.

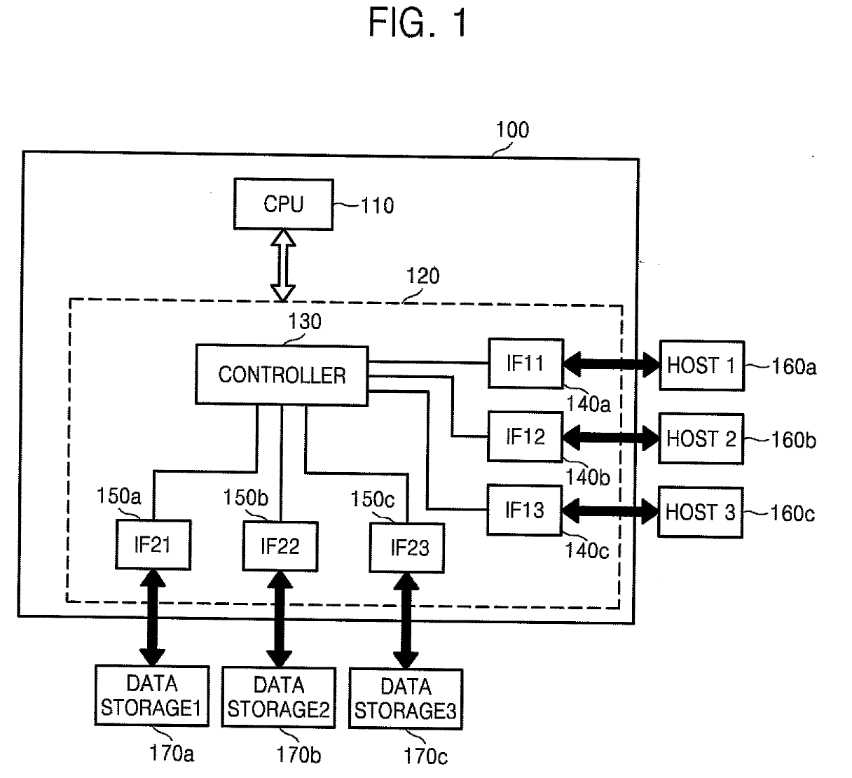

FIG. 1 is a block diagram of an electronic system 100 according to an exemplary embodiment of one or more of the inventive concepts described herein. Referring to FIG. 1, the electronic system 100 includes a central processing unit (CPU) 110 and an interface unit 120.

The CPU 110 executes a variety of applications dependent upon, for example, the functionality and programming of system 110 and user and other commands input into the system 110.

The interface unit 120 is operatively interposed between and functions as an interface between the CPU 110 and a plurality of host and storage devices. In the non-limiting example of FIG. 1, the interface 120 is connected to three host devices, namely, host devices HOST1 (160a), HOST2 (160b), and HOST3 (160c). In addition, this example, the interface 120 is connected to three storage devices, namely storage devices DATA STORAGE1 (170a), DATA STORAGE2 (170b), and DATA STORAGE3 (170c).

The interface unit 120 includes a controller 130 and a plurality of first interface devices and a plurality second interface devices. In the non-limiting example of FIG. 1, the interface unit 120 includes three first interface devices, namely, interface devices IF11 (140a), i IF12 (140b), and IF13 (140c). Also in this example, the interface unit 120 includes three second interface devices, namely, interface devices IF21 (150a), IF22 (150b), and IF23 (150c). The electronic system 100 exchanges data with the host devices 160a, 160b, and 160c via the first interface devices 140a, 140b, and 140c, respectively, and with the data storage devices 170a, 170b, and 170c via the second interface devices 150a, 150b, and 150c, respectively.

Each of the first interface devices 140a, 140b, and 140c and the second interface devices 150a, 150b, and 150c may be implemented using any of a variety of industry-standard interfaces. As examples, the first interface devices 140a, 140b, and 140c may independently be one of a universal serial bus (USB) interface, a wireless universal serial bus (WUSB) interface, and a Zigbee interface. Also as examples, the second interfaces 150a, 150b, and 150c may independently be one of a Secure Digital High Capacity (SD-HC) interface, a NAND flash interface, a multimedia card (MMC) interface, an advanced technology attachment (ATA) interface, and a compact flash (CF) interface. However, neither the embodiment nor the inventive concepts as a whole are limited to these specific examples.

The data storage s 170a, 170b, and 170c may be included in the interface unit 120. Also, the data storage devices 170a, 170b, and 170c may be removable from the interface unit 120.

In addition, the interface unit 120 may, for example, be implemented in a single module, such as on a single semiconductor chip or chip package. As non-limiting examples, the interface unit 120 may be mounted by using a package such as PoP (Package on Package), ball grid arrays (BGAs), chip scale packages (CSPs), a plastic leaded chip carrier (PLCC), a plastic dual in-line package (PDIP), die in waffle pack, die in wafer form, chip on board (COB), a ceramic dual in-line package (CERDIP), a plastic metric quad flat pack (MQFP), a thin quad flatpack (TQFP), small outline (SOIC), a shrink small outline package (SSOP), a thin small outline (TSOP), a thin quad flatpack (TQFP), system in package (SIP), a multi chip package (MCP), a wafer-level fabricated package (WFP), and a wafer-level processed stack package (WSP).

In the example of the present embodiment, the controller 110 is a processing unit which controls data communications with the host devices 160a, 160b, and 160c and the data storage devices 170a, 170b, and 170c via the first interfaces 140a, 140b, and 140c and the second interfaces 150; 150b, and 150c. In addition, the controller 110 is configured, independently of the CPU 110 and without intervention of the CPU 110, to store data received via the first interfaces 140a, 140b, and 140c in at least one of the data storage devices 170a, 170b, and 170c and to transfer the data stored in the at least one data storage to at least one of the host devices 160a, 160b, and 160c via a corresponding one of the second interfaces 150; 150b, and 150c.

In the process of storing the received data in the data storage devices 170a, 170b, and 170c, the controller 130 converts the received data to data of an interfacing specification corresponding to the data storage to store the data, and outputs the converted data. In the process of outputting the data stored in the data storage devices 170a, 170b, and 170c to the host devices 160a, 160b, and 160c, the controller 130 converts the stored data to data of an interfacing specification corresponding to the host to receive the data, and outputs the converted data.

As described above, in the electronic system 100 according to the present exemplary embodiment, the CPU 110 does not control the data input/output operation and the data input/output operation may be controlled by the interface unit 120. Thus, in the electronic system 100 according to the present exemplary embodiment, since it is not necessary for the CPU temporarily cease other data processing operations to control the data input/output operation, the data processing capabilities of the CPU 110 may be improved. Also, in the electronic system 100 according to the present exemplary embodiment, it is possible for the host devices 160a, 160b, and 160c to share the data stored in the data storage devices 170a, 170b, and 170c by using the interface unit 120.

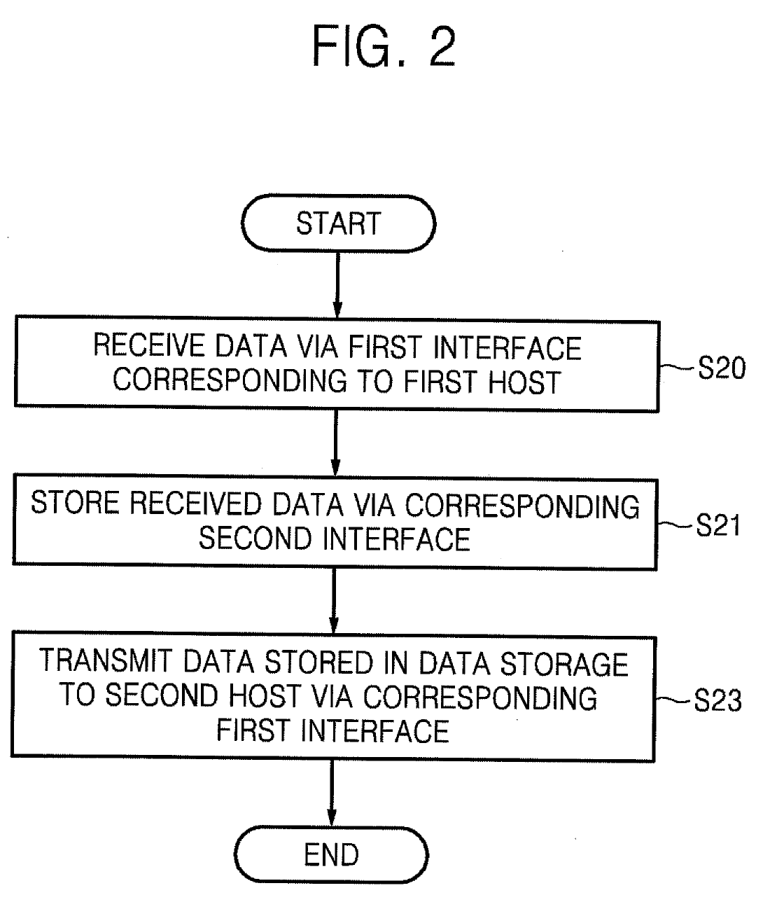

FIG. 2 is a flowchart for explaining a data input/output method in the electronic system 100 of FIG. 1. Referring to FIGS. 1 and 2, the electronic system 100 receives data from a corresponding one of the host devices 160a, 160b, and 160c via a corresponding one of the first interfaces 140a, 140b, and 140c (S20). The received data is data of an interface specification between the electronic system 100 and the corresponding first host.

The interface unit 120 stores the data received from the corresponding first host in a corresponding one of the data storage devices 170a, 170b, and 170c (S21). The controller 130 of the interface unit 120 converts the received data to data of the interface specification between the electronic system 100 and the corresponding data storage and outputs converted data to a corresponding data storage via a corresponding interface of the second interfaces 150a, 150b, and 150c.

The interface unit 120 outputs the data stored in the corresponding data storage to a corresponding one of the host devices 160a, 160b, and 160c via a corresponding one of the first interfaces 140a, 140b, and 140c (S23). The controller 130 of the interface unit 120 converts the data stored in the corresponding data storage to data of the interface specification between the electronic system 100 and the corresponding host and outputs converted data to the corresponding host.

According to the present embodiment, the process steps S20, S21 and S23 are automatically executed by the controller 130 independently of the CPU 110 and without intervention of the CPU 110. In other words, data communications between the electronic system 100 and the host devices 160a, 160b, and 160c, and between the electronic system 100 and the data storage devices 170a, 170b, and 170c, are controlled by the interface unit 120, and not by the CPU 110.

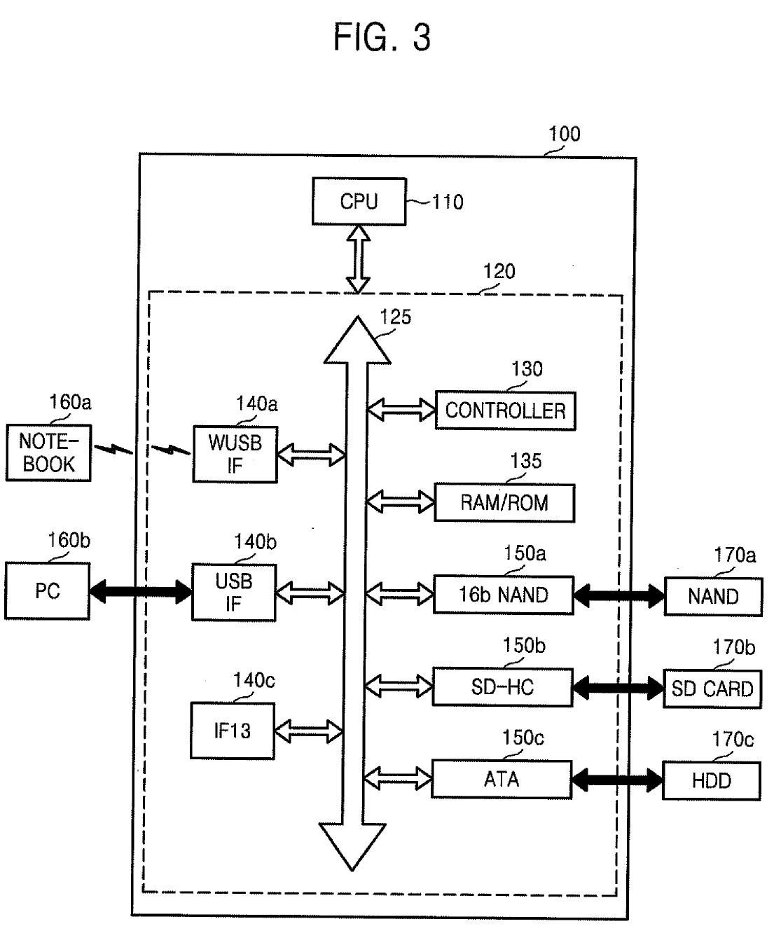

FIG. 3 is a block diagram illustrating an exemplary embodiment of the interface unit 120 and presenting an example in which the host devices include a notebook 160a and a PC 160b, and the storage devices include NAND flash memory 170a, a Secure Digital (SD) card 170b and a hard disk drive (HDD) 170c.

Referring to FIG. 3, the interface unit 120 of this example includes a controller (processor) 130, a memory 135, a plurality of interface devices, and a bus system 125 for exchanging data amount the components of the interface unit 120.

The memory 135 may include random access memory (RAM), read only memory (ROM), or a combination of RAM and ROM, and functions to temporarily and/or permanently store data under control of the controller 130.

The interface devices of the interface unit 120 include a wireless USB interface 140a for exchanging data with the notebook 160a and a USB interface 140b for exchanging data with the PC 160b. The interface devices further include a 16-bit NAND interface for exchanging data with the NAND flash memory 170a, an SD-High Capacity (SD-HC) interface for exchanging data with the SD card 170b, and an ATA interface for exchanging data with the HDD 170c.

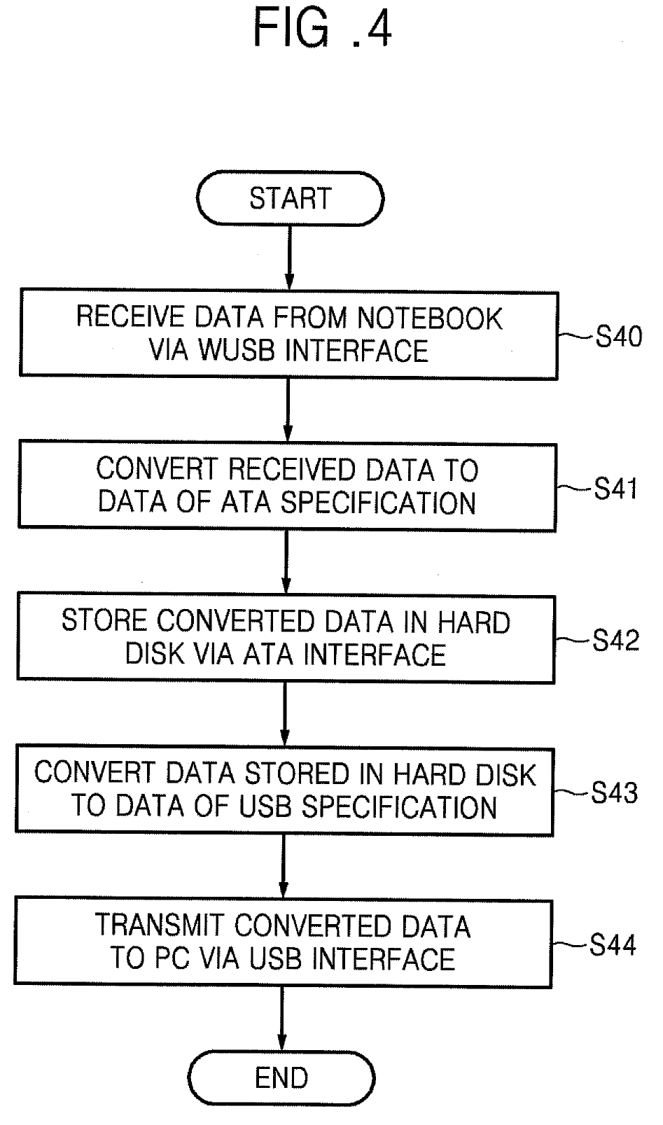

FIG. 4 is a flowchart for explaining an example of data communications between the electronic system 100, the notebook 160a, and the PC 160b which is illustrated in FIG. 3. In particular, FIG. 4 illustrates an example in which data stored in the notebook 160a may be shared by the PC 160b,

Referring to FIGS. 3 and 4, the interface unit 120 receives data and, for example, a store command/request from the notebook 160a via the WUSB interface 140a (S40). The controller 130 of the interface unit 120 converts the received data to data of an ATA specification (S41). The interface unit 120 outputs the ATA specification converted data to the hard disk drive 170c via the ATA interface 150c and the data is stored in the hard disk drive 170 170c (542). Thus, steps 540, S41 and S42 are executed by the controller 130, independently of the CUP 110, to store the data transmitted from the notebook 160a in the electronic system 100. As described next, the stored data may now be shared with the PC 160b.

In response, for example, to a read command/request from the PC 160c, the controller 130 of the interface unit 120 receives data of an ATA specification from the hard disk drive and converts the received data to data of a USB specification (S43). The USB specification converted data is transmitted to the PC 160b via the USB interface 140b (S44). In this manner, steps S43 and S44 are executed by the controller 130, independently of the CUP 110, to transmit the notebook 160a originated data to the PC160b.

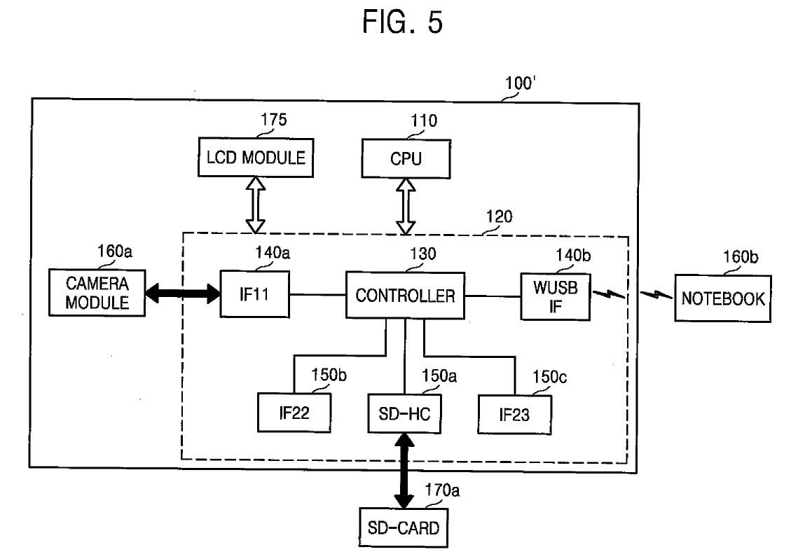

FIG. 5 is a block diagram illustrating an example in which the inventive concepts are utilized in a mobile telephone device 100′. In this example, the mobile telephone device 100′ exchanges data with a notebook 160b and an SD card 170a.

As shown, the mobile telephone device 100′ of this example includes camera module 160a for providing camera functionality, and an LCD module 175 for providing display functionality. In addition, the device 100′ includes a CPU 110 and interface unit 120 as in the previous embodiments.

The interface unit 120 includes a controller 130, an interface IF11 140a for interfacing with the camera module 160a, an interface WUSP IF 140b for interfacing with the notebook 160b, and an interface SD-HC 150a for interfacing with the SC card 170a. In addition, two additional unused interfaces IF22 150b and IF23 150c are equipped in the device 100′.

The camera module 160a included in the electronic system 100′ may instead be connected to the interface unit 120 a system bus (not shown) of the electronic system 100′. Also, the camera module 160a may include separate data storage for storing data or use the SD card 170a.

It should be apparent that the inventive concepts may also be utilized in other portable applications, such as portable computers, digital cameras, personal digital assistants (PDAs), cellular telephones, MP3 players, portable multimedia players (PMPs), automotive navigation systems, memory cards, and electronic dictionaries.

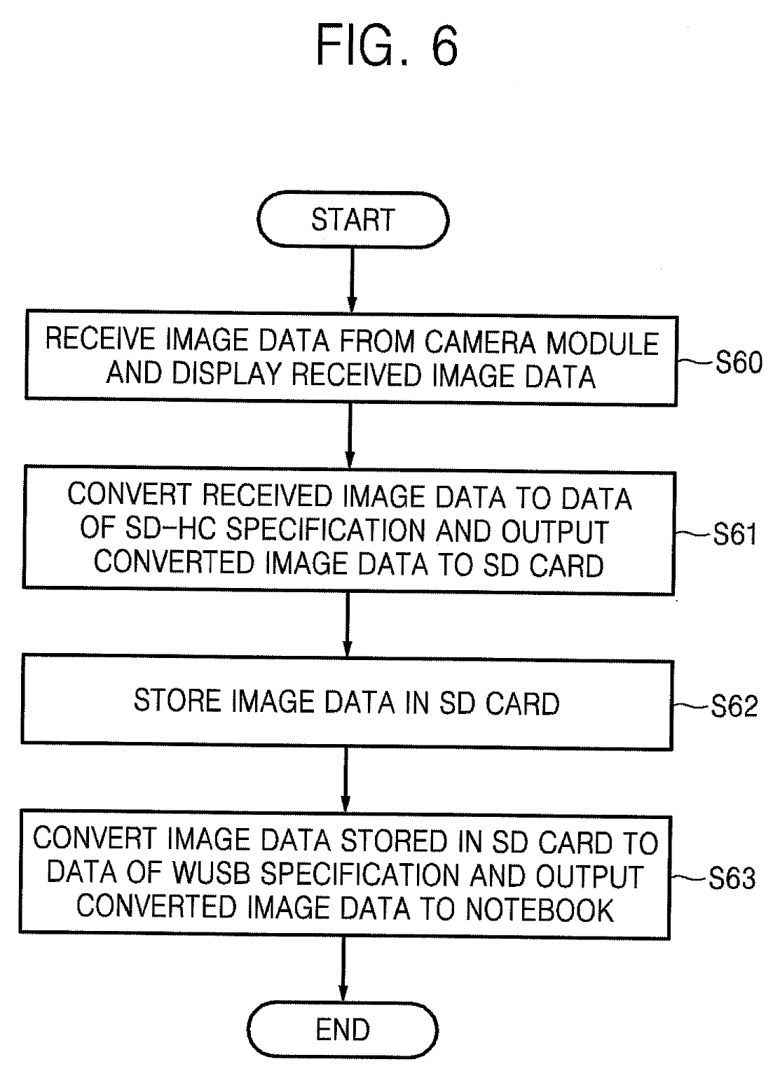

The mobile telephone device 100′ of FIG. 5 controls data communication in essentially the same manner as described above in connection with the previous described embodiments. FIG. 6 is a flowchart for explaining an example of data communication between the electronic system 100′ and the notebook 160b illustrated in FIG. 5. In particular, FIG. 6 shows an example of sharing image data generated from the camera module 160a with the notebook 160b.

Referring collectively to FIGS. 5 and 6, the interface unit 120 receives the data generated from the camera module 160a via the first interface 140a and the electronic system 100′ display the received image data in the LCD module 175 (S60). The controller 130 of the interface unit 120 converts the image data received from the camera module 160a to data of an SD-HC specification and outputs the converted data to the SD card 170a (S61). The SD card 170a stores the received data (S62).

The controller 130 of the interface unit 120 converts the data stored in the SD card 170a to data of a WUSB specification that is an interfacing specification with the notebook 160b and outputs the converted data to the notebook 160b via the WUSB interface (S63). The notebook 160b displays and/or stores the received image data. In this manner, the notebook 160b and the camera module 160a that constitute different host devices may share image data under the control of the interface unit 120 without using processing resources of the CPU 110.

While the inventive concept has been particularly shown and described with reference to exemplary embodiments thereof, it will be understood that various changes in form and details may be made therein without departing from the spirit and scope of the following claims.

What is claimed is:

1. An interface unit comprising:
a plurality of first interface devices for connecting a plurality of host devices;
a plurality of second interface devices for connecting a plurality of data storage devices; and
a controller for controlling data communication among the plurality of host devices and the plurality of data storage devices via the plurality of first interfaces and the plurality of second interfaces.

2. The interface unit of claim 1, wherein each of the plurality of first interfaces and the plurality of second interfaces is a standard interface.

3. The interface unit of claim 1, wherein the first interfaces include at least one of a universal serial bus (USB) interface, a wireless universal serial bus (WUSB) interface, and a Zigbee interface, and the second interfaces includes at least one of a Secure Digital High Capacity (SD-HC) interface, a NAND flash interface, a multimedia card (MMC) interface, an advanced technology attachment (ATA) interface, and a compact flash (CF) interface.

4. The interface unit of claim 1, wherein controller is configured to share data stored in each of the plurality of data storage devices among the plurality of host devices.

5. The interface unit of claim 4, wherein the controller stores data received via the plurality of first interfaces in at least one of the plurality of data storage devices, and transmits the data stored in the at least one data storage device to at least one of the plurality of host devices.

6. The interface unit of claim 5, wherein the controller converts the received data to data of an interfacing specification corresponding to the at least one data storage device and outputs the converted data to the at least one data storage device, and converts the stored data to data of an interfacing specification corresponding to the at least one host device and outputs the converted data to the at least one host device.

7. The interface unit of claim 6, wherein at least of the plurality of data storage devices is removable.

8. The interface unit of claim 6, wherein the plurality of first interfaces, the plurality of second interfaces, and the controller are included in a single module.

9. The interface unit of claim 8, wherein the single module is a semiconductor chip or chip package.

10. An electronic system comprising a central processing unit and an interface unit, wherein the interface unit comprises:
a plurality of first interfaces for connecting a plurality of host devices;
a plurality of second interfaces for connecting a plurality of data storage devices; and
a controller for controlling data communication, independently of the central processing unit, among the plurality of host devices and the plurality of data storage devices via the plurality of first interfaces and the plurality of second interfaces.

11. The electronic system of claim 10, wherein the controller is configured to share data stored in each of the plurality of data storage devices among the plurality of host devices.

12. The electronic system of claim 11, wherein the controller converts the received data to data of an interfacing specification corresponding to the at least one data storage device and outputs the converted data to the at least one data storage device, and converts the stored data to data of an interfacing specification corresponding to the at least one host device and outputs the converted data to the at least one host device.

13. The electronic system of claim 10, wherein the first interfaces include at least one of a universal serial bus (USB) interface, a wireless universal serial bus (WUSB) interface, and a Zigbee interface, and the second interfaces includes at least one of a Secure Digital High Capacity (SD-HC) interface, a NAND flash interface, a multimedia card (MMC) interface, an advanced technology attachment (ATA) interface, and a compact flash (CF) interface.

14. The electronic system of claim 10, wherein the electronic system is a portable electronic device.

15. The electronic system of claim 14, wherein the portable electronic system is one of a portable computer, digital camera, personal digital assistant (PDA), mobile telephone, MP3 players, portable multimedia player (PMP), automotive navigation system, memory card, and electronic dictionary.
